(19) United States
(12) Patent Application Publication
(10) Pub. No.: US 2007/0192482 A1
(43) Pub. Date: Aug. 16, 2007

(54) INTERACTIVE BANDWIDTH MODELING AND NODE ESTIMATION

(75) Inventors: Curtiss Smith, Horsham, PA (US); Brent L. Patterson, Warrington, PA (US); Steve F. Nikola, Marlboro, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/539,495

(22) Filed: Oct. 6, 2006

Related U.S. Application Data
(60) Provisional application No. 60/724,494, filed on Oct. 8, 2005.

(51) Int. Cl. G06F 15/173

(52) U.S. Cl. 709/224

(57) ABSTRACT

An interactive bandwidth modeling tool allows a user to estimate the bandwidth requirements in a network for a period of time of interest which may be a plurality of years. The user enters network plant parameters which are used to estimate the bandwidth requirements of the network for a variety of types of signals, including upstream and downstream signals. The estimated bandwidth requirements are displayed on a display in either a graphical form or a histogram form. The user may select to display one or more of the plant parameters simultaneously with the display of the bandwidth requirements.

This application claims the benefit of provisional application No. 60/724,494, filed on Oct. 8, 2005, which is herein incorporated in its entirety.

### FIELD OF THE INVENTION

The present invention relates to bandwidth modeling for node size estimation in a network.

### BACKGROUND

Coaxial cable television systems have been in widespread use for many years and extensive networks have been developed. The extensive and complex networks are often difficult for a cable operator to manage and monitor. A typical cable network generally contains a headend which is usually connected to several nodes which provide content to a cable modem termination system (CMTS) containing several receivers, each receiver connects to several modems or set top boxes of many subscribers, e.g., a single receiver may be connected to hundreds of modems and set top boxes. In many instances several nodes may serve a particular area of a town or city.

Cable systems are carrying increasing volumes of communications and increasing types of communications. Many cable systems support upstream communications from an end user to the cable system, such as to the CMTS, and downstream communications from the cable system to the end user. Both upstream and downstream communications may have bandwidth further allocated into bandwidth for wireless, high speed data (HSD), voice over IP (VoIP), video on demand (VOD), digital video broadcast, and analog video broadcast. The rapidly increasing volumes and complexity of communications makes it difficult for cable operators to accurately estimate the resources which will be required to meet the future demands.

U.S. Pat. No. 7,073,192 filed as application Ser. No. 09/521,770 filed on Mar. 9, 2000, herein incorporated by reference in its entirety, provides a technique for estimating the node size required to handle increased volume loads. However, cable operators need an enhanced tool which allows a user associated with a cable operator to easily determine cable plant loads in graphical manners.

### SUMMARY OF THE INVENTION

An apparatus for modeling bandwidth of a network may comprise: a processor configured to receive network parameters from a user and to estimate bandwidth usage based on the network parameters; a display configured to display the estimated bandwidth usage simultaneously with selected parameters, wherein the processor instructs the display to display network parameters selected by the user at the same time as displaying the estimated bandwidth usage and to display the estimated bandwidth in a manner selected by the user.

In the apparatus, the processor may instruct the display to display a graphic representation of the estimated bandwidth usage for a period of time of interest which may be a plurality of years. The graphic representation may include a representation of upstream bandwidth requirement estimates and downstream bandwidth requirement estimates.

The processor may instruct the display to display a histogram representation of the estimated bandwidth usage for a period of time of interest which may be a plurality of years. The histogram representation may include a representation of an estimate for bandwidth usage associated with downstream wireless signals, downstream high speed data signal, downstream VoIP signals, downstream video on demand signal, digital video broadcast signals, analog video broadcast signal, and downstream unusable spectrum.

The network parameters may include plant parameters, video parameters, HSD parameters, VoIP parameters, and wireless parameters. The processor may be configured to instruct the display to display more than one network parameter is displayed simultaneously upon selection by the user.

A method of modeling bandwidth of a network may comprise the steps of: receiving network parameters; calculating bandwidth requirements of the network; estimating bandwidth requirements of the network for a time period of interest; and displaying the estimated bandwidth requirements simultaneously with selected network parameters, wherein the network parameters displayed are selected by the user to be displayed at the same time as displaying the estimated bandwidth usage and the estimated bandwidth is displayed in a manner selected by the user.

In the method, a graphic representation of the estimated bandwidth usage for a period of time of interest which may be a plurality of years may be displayed. The graphic representation may include a representation of upstream bandwidth requirement estimates and downstream bandwidth requirement estimates.

Also in the method, histogram representation of the estimated bandwidth usage for a period of time of interest which may be a plurality of years may be displayed. The histogram representation may include a representation of an estimate for bandwidth usage associated with downstream wireless signals, downstream high speed data signal, downstream VoIP signals, downstream video on demand signal, digital video broadcast signals, analog video broadcast signal, and downstream unusable spectrum.

In the method, the network parameters may include plant parameters, video parameters, HSD parameters, VoIP parameters, and wireless parameters. The processor may be configured to instruct the display to display more than one network parameter is displayed simultaneously upon selection by the user.

A computer readable medium may carry instructions for a computer to model bandwidth of a network, the instructions may instruct the computer to perform a method comprising the step of: receiving network parameters; calculating bandwidth requirements of the network; estimating bandwidth requirements of the network for a time period of interest; and displaying the estimated bandwidth requirements simultaneously with selected network parameters, wherein the network parameters displayed are selected by the user to be displayed at the same time as displaying the estimated bandwidth usage and the estimated bandwidth is displayed in a manner selected by the user.

In the method contained in the instructions on the computer readable medium, a graphic representation of the estimated bandwidth usage for a period of time of interest which may be a plurality of years may be displayed. The graphic representation may include a representation of upstream bandwidth requirement estimates and downstream bandwidth requirement estimates.

Also in the method contained in the instructions on the computer readable medium, histogram representation of the estimated bandwidth usage for a period of time of interest a plurality of years may be displayed. The histogram representation may include a representation of an estimate for bandwidth usage associated with downstream wireless signals, downstream high speed data signal, downstream VoIP signals, downstream video on demand signal, digital video broadcast signals, analog video broadcast signal, and downstream unusable spectrum.

In the method contained in the instructions on the computer readable medium, the network parameters may include plant parameters, video parameters, HSD parameters, VoIP parameters, and wireless parameters. The processor may be configured to instruct the display to display more than one network parameter is displayed simultaneously upon selection by the user.

The invention allows a cable operator to more precisely estimate the architecture needed to meet the increasing and dynamic needs of their customers. In this manner, the cable operator can be more competitive and provide more reliable service to each of its customers, e.g. video service and VoIP service.

### BRIEF DESCRIPTION OF THE DRAWINGS

In accordance with the principles of the invention:

FIG. 1 illustrates an exemplary computer system which may be used to implement the invention.

FIG. 2 illustrates an exemplary method in accordance with the principles of the invention.

FIGS. 3-7 illustrate exemplary screen shots of an interactive bandwidth model created from the processes of the present invention.

### DETAILED DESCRIPTION OF THE INVENTION

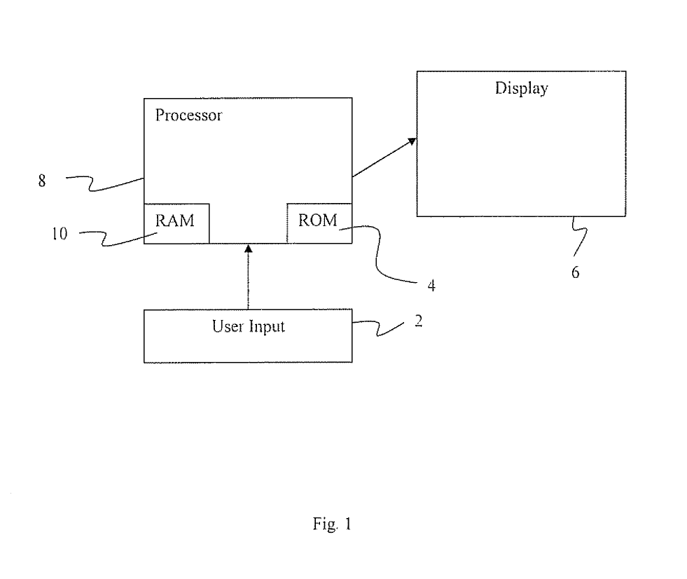

An interactive bandwidth model in accordance with the present invention is shown in FIG. 1. The bandwidth modeling tool is preferably provided as a computer program implemented by a processor 8 in association with a RAM 10 and a ROM 4 which may be located in a PC as illustrated in FIG. 1. The user can provide inputs related to the interactive bandwidth model through a user input 2, which may include a keyboard, an interface for a removable storage device or remote storage device, or any other type of user input device. The model results can also be viewed in various manners on a display 6. Display 6 may be any type of display, including projection, CRT and LCD displays.

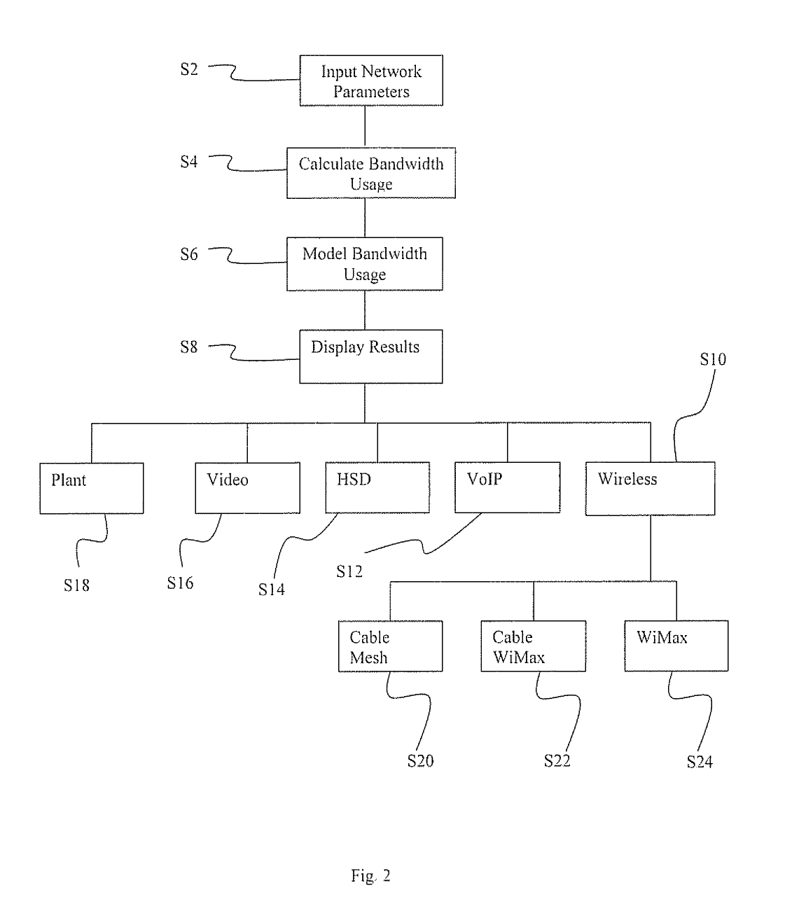

A method associated with the interactive bandwidth model is illustrated in FIG. 2. As illustrated in FIG. 2, a user preferably provides input plant parameters into the modeling tool. The interactive bandwidth model considers cable plant parameters, video parameters, high-speed data (HSD) parameters, voice over IP (VOIP) Parameters and wireless parameters. The plant parameters may consider the number of homes per node for each year of estimation, the MSO penetration, the number of nodes and/or transmitters. The parameters for the bandwidth allocation may also be provided, e.g. the start and end of the upstream spectrum; the start and end of the downstream spectrum.

As illustrated in step S4, the bandwidth usage of the user's network is calculated. The tool calculates the bandwidth usage by determining the available frequency spectrum available in both the upstream and downstream paths using the passband information entered into the tool. The non-dynamic service bandwidth requirements may be subtracted from the available bandwidth. Examples of these non-dynamic services are broadcast services in the downstream direction and polled services in the upstream and downstream passbands. The services have a dedicated bandwidth that is available 100% of the time. The remaining bandwidth is available for interactive or dynamic services. Each of the upstream and downstream bandwidth is then further allocated into bandwidth for wireless, high speed data (HSD), voice over IP (VoIP), video on demand (VOD), digital video broadcast, and analog video broadcast.

Using the plant parameters entered, including the subscriber data rates and payload data rates, the tool calculates the amount of subscribers that can be simultaneously supported in that service's channel. Once this information is known, the model then uses the other parameters from the services including the penetration rates and the simultaneous use rates along with the interactive bandwidth available to determine the bandwidth requirements on a node. The tool may initially start with a large number of homes passed per node that is an over-estimate, which can be based upon a network maximum. The penetration and simultaneous use rates may then used to determine the number of people simultaneously using each service. Once this number has been determined, it is divided by the users per service channel in order to determine how many service channels are required. This number is then multiplied by the bandwidth required for each service channel in order to arrive at a total interactive bandwidth required for each service with the given node size. This required bandwidth is then compared with the available interactive bandwidth.

These calculations are done separately for both the upstream and downstream passbands. The tool then compares the results for the both upstream and downstream passbands that satisfy the available bandwidth and displays the lower number. The constraining passband is also shown so that the user knows whether the system is upstream limited or downstream limited. For example, several plant assumptions may be made such as node size=500 HP, a 3-way split on the downstream transmitter, a 3-way combine on node upstream, fixed service penetrations with a CATV service=80%, a digital subscriber=60%; HSD Simultaneous use=10% (typical user), 20% (power user). Other assumptions may be that the downstream passband starts at 54 MHz and the upstream passband is from 5 MHz to 42 MHz, and we assume that we can use all of it. Trends may also be considered, such as the number of VoIP lines per subscriber expected to be 2 in the year 2007 and 3 in the year 2009. Other trends expected over the period of interest (e.g. years) may be the number analog broadcast 6 MHz channels, the number of digital broadcast 6 MHz channels, the number of digital simulcast 6 MHz channels; HDTV broadcast 6 MHz channels, SDTV VOD 6 MHz channels, VoIP service penetration, HSD service penetration, typical HSD user downstream data rate, typical HSD user upstream data rate, power HSD user downstream data rate, and power HSD upstream data rate.

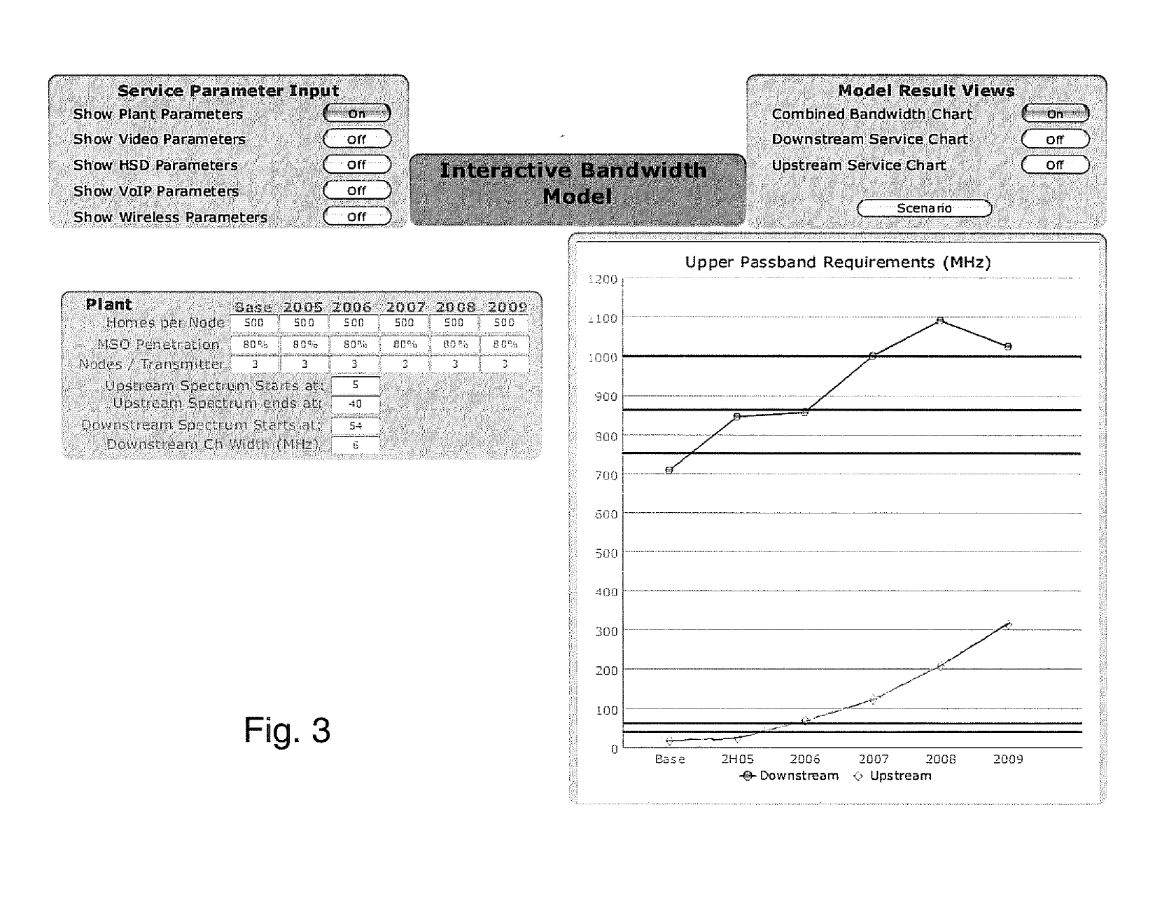

An exemplary view is the combined bandwidth chart which may preferably illustrate the downstream and upstream bandwidth as estimated for several years of interest, as shown in FIG. 3. The user may select to display both the upstream and downstream bandwidths or either of the upstream and downstream bandwidths separately. The user may select to show plant parameters, video parameters, HSD parameters, VoIP parameters, and wireless parameters. As illustrated, the displayed plant parameters may include the number of homes per node, MSO penetration, nodes/transmitter, the upstream spectrum starting and ending limits, and the downstream spectrum starting and ending limits. The bandwidth requirements may be a downstream service chart, which preferably shows the estimated bandwidth required for: downstream wireless, downstream HSD, downstream VoIP, downstream VOD, digital video broadcast, analog video broadcast, and un-usable downstream portions.

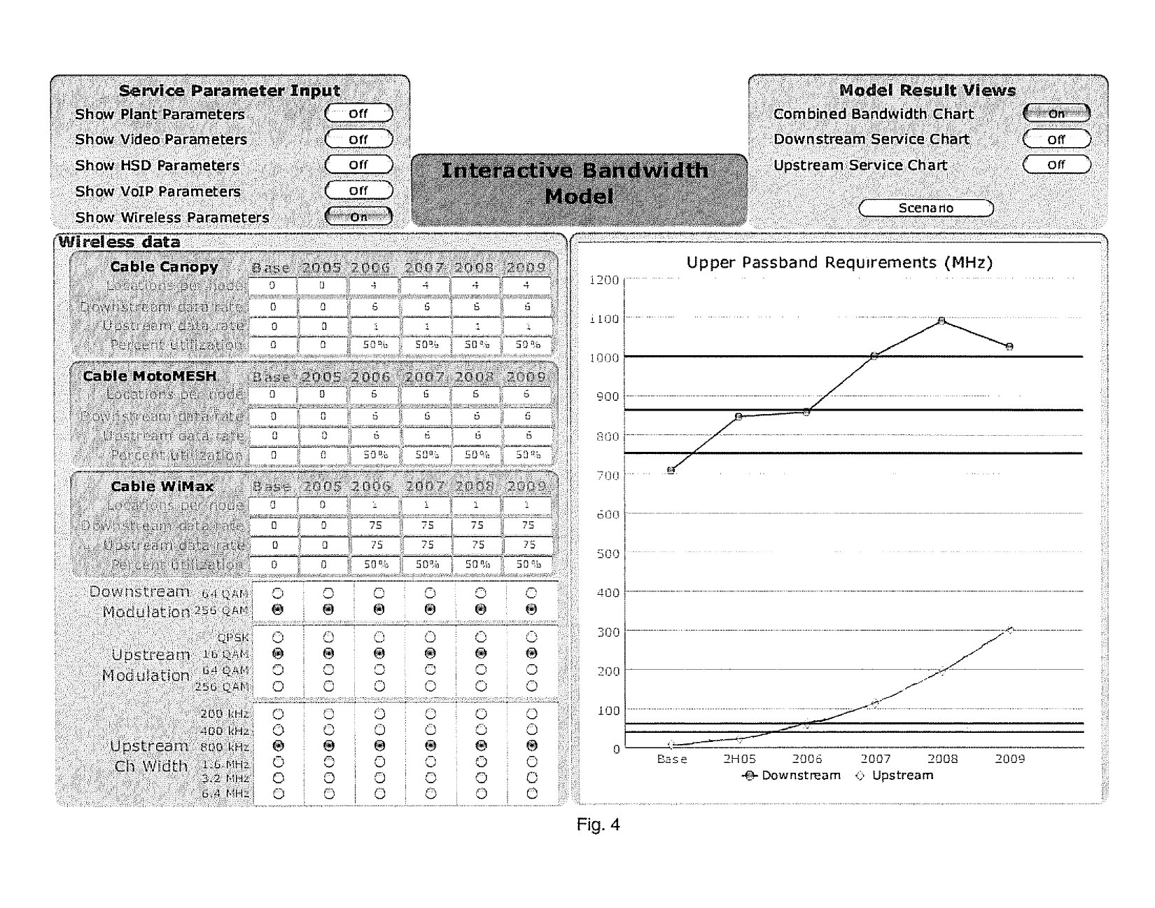

Another view, as shown in FIG. 4 illustrates the combined bandwidth chart with wireless data parameters. The wireless data may include any type of wireless data system such as Cable Canopy™ (Trademark of Motorola) which contains parameters for locations per node, downstream data rate, upstream data rate, and percent utilization. The wireless data may also contain cable MotoMesh™ (Trademark of Motorola) which may include locations per node, downstream data rate, upstream data rate, and percent utilization. The wireless data may also contain parameters for Cable WiMax™ (Trademark of Motorola) which may also include locations per node, downstream data rate, upstream data rate, and percent utilization. The modulation parameters may also be displayed, including downstream modulation of 64 QAM and 256 QAM, upstream modulation of QPSK, 16 QAM, 64 QAM, and 256 QAM. The parameters for the upstream channel width may also be displayed, ranging from 200 KHz to 6.4 MHz.

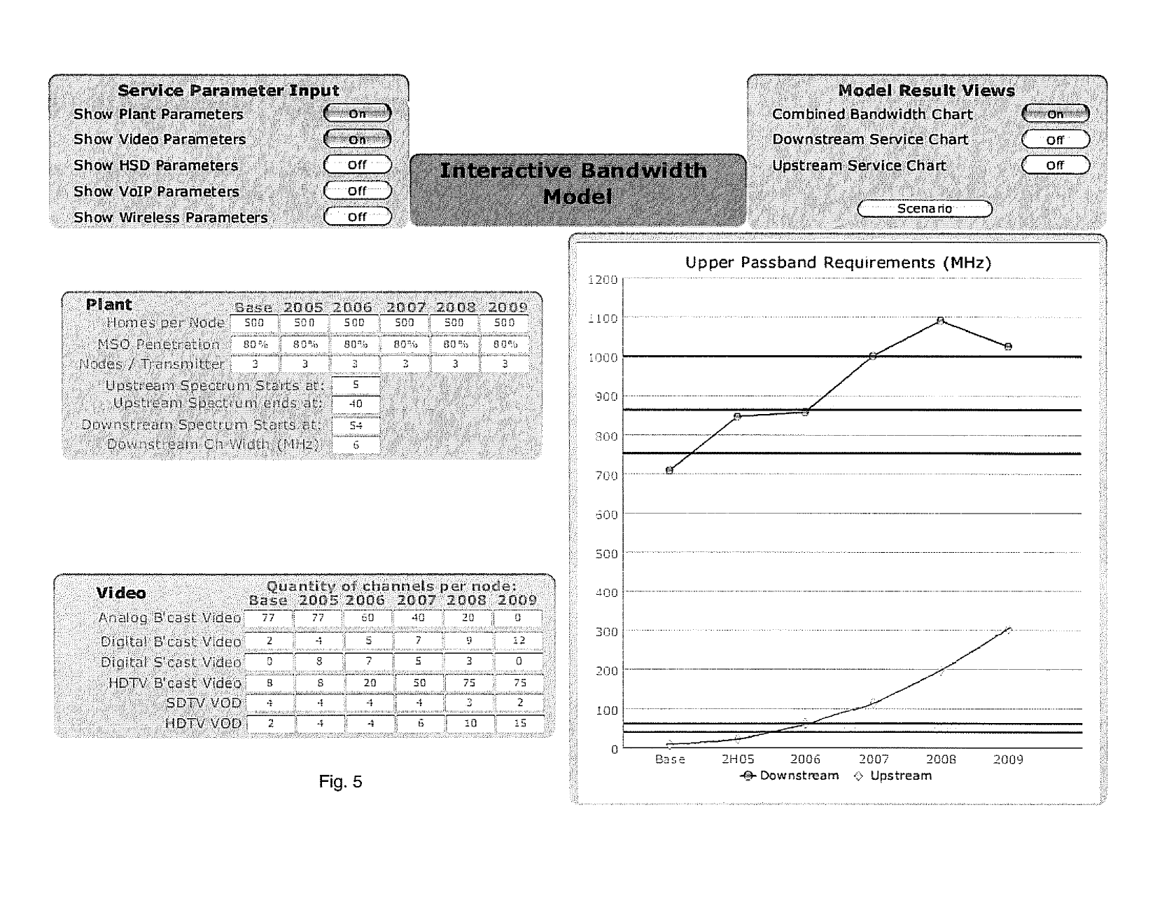

Another view, as shown in FIG. 5 may show plant parameters and video parameters. As shown, the video parameters may include analog broadcast video, digital broadcast video, digital simulcast video, HDTV broadcast video, SDTV video on demand (VOD), and HDTV VOD. The parameters may be displayed for several years of interest.

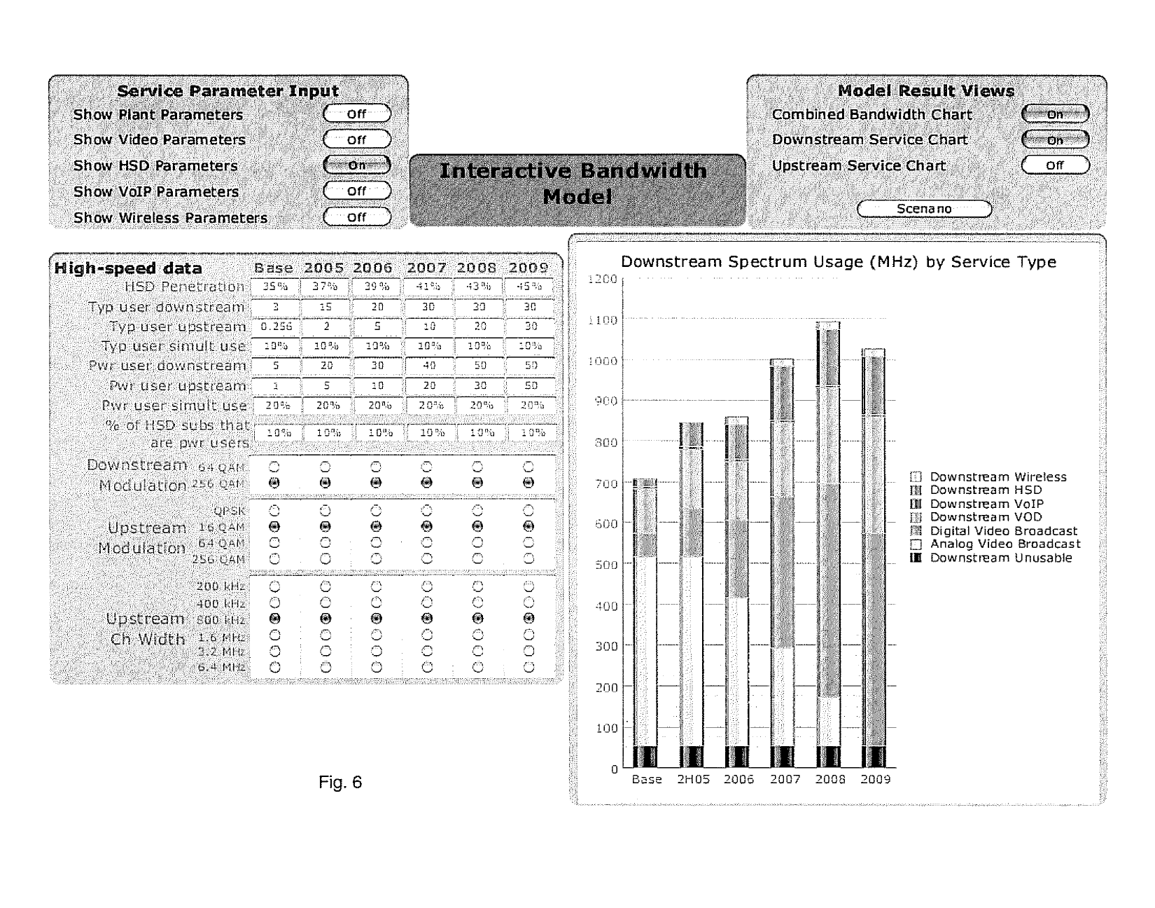

As illustrated in FIG. 6, estimates for downstream spectrum usage may be displayed in a histogram bar chart. Different frequency bands associated with different types of signals may be illustrated in different colors, with different shading, or with different markings. As illustrated, the histograms may illustrate the estimates for a plurality of years. The spectrum bandwidth illustrated may include downstream wireless, downstream HSD, downstream VoIP, downstream VOD, digital video broadcast, analog video broadcast, and downstream unusable spectrum. FIG. 6 also illustrates the high speed data parameter estimates for high-speed data bandwidth requirements for each year of consideration. The high-speed data parameter estimates may include consideration of: HSD penetration, the typical user downstream data requirements, the typical user upstream data requirements, the typical user simultaneous use requirements, the power use downstream and upstream, simultaneous power use; and the percentage of HSD subscribers that are power users. The modulation type may be considered, such as 64 QAM or 256 QAM for downstream modulation; and QPSK, 16 QAM, 64 QAM, and 256 QAM for upstream modulation. The channel width may also be estimated, such as 200 KHz to 6.4 MHz for the upstream channel.

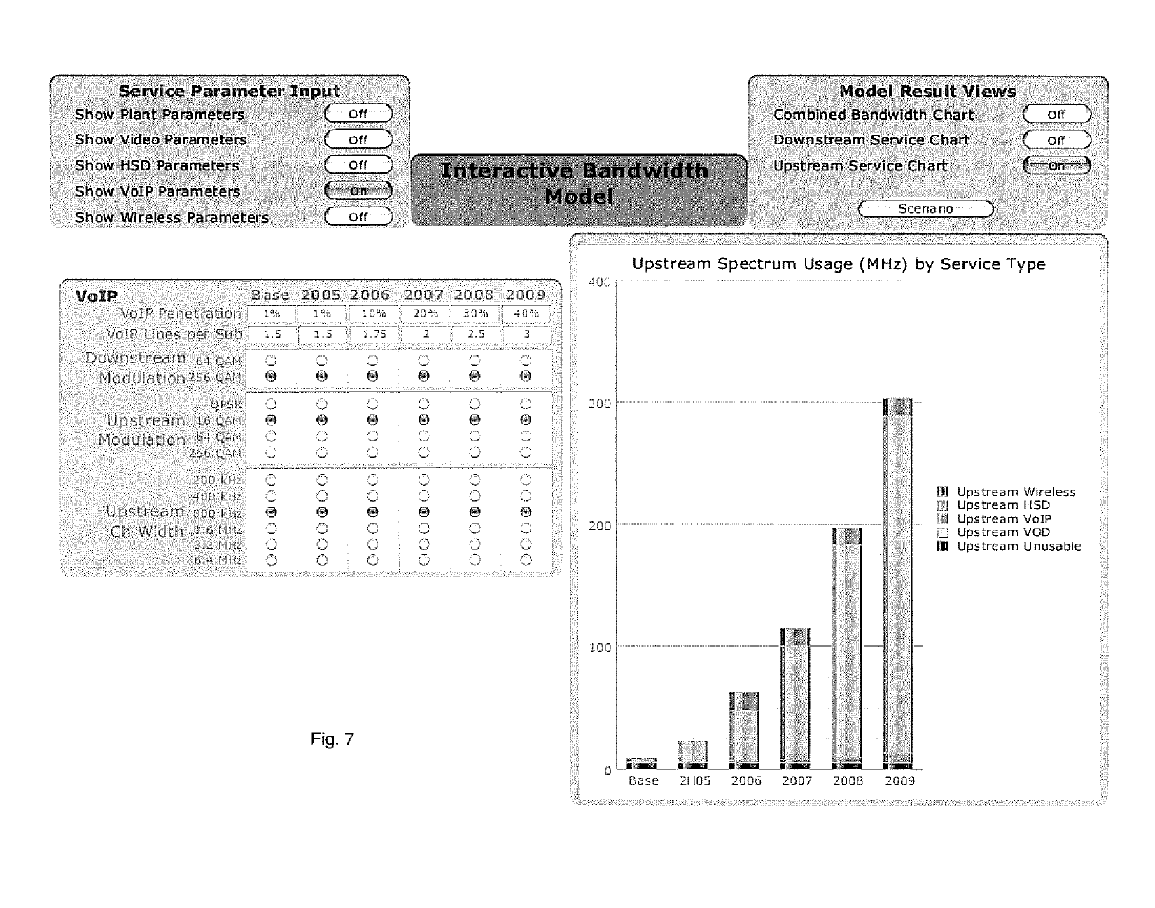

As illustrated in FIG. 7, estimates for upstream spectrum usage may also be displayed in a histogram bar chart. Different frequency bands associated with different types of signals may be illustrated in different colors, with different shading, or with different markings. As illustrated, the histograms may illustrate the estimates for a plurality of years. The spectrum bandwidth illustrated may include upstream wireless, upstream HSD, upstream VoIP, upstream VOD, and upstream unusable spectrum. FIG. 7 also illustrates the VoIP data parameter estimates for bandwidth requirements for each year of consideration. The VoIP data parameter estimates may include consideration of: VoIP penetration, and VoIP lines per subscriber. The modulation type may be considered, such as 64 QAM or 256 QAM for downstream modulation; and QPSK, 16 QAM, 64 QAM, and 256 QAM for upstream modulation. The channel width may also be estimated, such as 200 KHz to 6.4 MHz for the upstream channel.

The processes in FIG. 2 may be implemented in hard wired devices, firmware or software running in a processor. A processing unit for a software or firmware implementation is preferably contained in processor 8. Any of the processes illustrated in FIG. 2 may be contained on a computer readable medium which may be read by processor 8. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals.

Those of skill in the art will appreciate that the invention allows a cable operator to more precisely estimate the architecture needed to meet the increasing and dynamic needs of their customers. In this manner, the cable operator can be more competitive and provide more reliable service to each of its customers, e.g. video service and VoIP service.

We claim:

1. An apparatus for modeling bandwidth of a network comprising:
a processor configured to receive network parameters from a user and to estimate bandwidth usage based on the network parameters;
a display configured to display the estimated bandwidth usage simultaneously with selected parameters,
wherein the processor instructs the display to display network parameters selected by the user at the same time as displaying the estimated bandwidth usage and to display the estimated bandwidth in a manner selected by the user.

2. The apparatus of claim 1, wherein the processor instructs the display to display a graphic representation of the estimated bandwidth usage for a period of time of interest.

3. The apparatus of claim 2, wherein the graphic representation includes a representation of upstream bandwidth requirement estimates and downstream bandwidth requirement estimates.

4. The apparatus of claim 1, wherein the processor instructs the display to display a histogram representation of the estimated bandwidth usage for a period of time of interest.

5. The apparatus of claim 4, wherein the histogram representation includes a representation of an estimate for bandwidth usage associated with downstream wireless signals, downstream high speed data signal, downstream VoIP signals, downstream video on demand signal, digital video broadcast signals, analog video broadcast signal, and downstream unusable spectrum.

6. The apparatus of claim 1, wherein the network parameters include plant parameters, video parameters, HSD parameters, VoIP parameters, and wireless parameters.

7. The apparatus of claim 6, wherein the processor is configured to instruct the display to display more than one network parameter is displayed simultaneously upon selection by the user.

8. A method of modeling bandwidth of a network comprising the steps of:
receiving network parameters;
calculating bandwidth requirements of the network;
estimating bandwidth requirements of the network for a time period of interest; and
displaying the estimated bandwidth requirements simultaneously with selected network parameters,
wherein the network parameters displayed are selected by the user to be displayed at the same time as displaying the estimated bandwidth usage and the estimated bandwidth is displayed in a manner selected by the user.

9. The method of claim 8, wherein a graphic representation of the estimated bandwidth usage for a period of time of interest is displayed.

10. The method of claim 9, wherein the graphic representation includes a representation of upstream bandwidth requirement estimates and downstream bandwidth requirement estimates.

11. The method of claim 8, wherein a histogram representation of the estimated bandwidth usage for a period of time of interest is displayed.

12. The method of claim 11, wherein the histogram representation includes a representation of an estimate for bandwidth usage associated with downstream wireless signals, downstream high speed data signal, downstream VoIP signals, downstream video on demand signal, digital video broadcast signals, analog video broadcast signal, and downstream unusable spectrum.

13. The method of claim 8, wherein the network parameters include plant parameters, video parameters, HSD parameters, VoIP parameters, and wireless parameters.

14. The method of claim 13, wherein the processor is configured to instruct the display to display more than one network parameter is displayed simultaneously upon selection by the user.

15. A computer readable medium carrying instructions for a computer to model bandwidth of a network, the instructions instructing the computer to perform a method comprising the step of:
receiving network parameters;
calculating bandwidth requirements of the network;
estimating bandwidth requirements of the network for a time period of interest; and
displaying the estimated bandwidth requirements simultaneously with selected network parameters,
wherein the network parameters displayed are selected by the user to be displayed at the same time as displaying the estimated bandwidth usage and the estimated bandwidth is displayed in a manner selected by the user.

16. The computer readable medium of claim 15, wherein a graphic representation of the estimated bandwidth usage for a period of time of interest is displayed.

17. The computer readable medium of claim 16, wherein the graphic representation includes a representation of upstream bandwidth requirement estimates and downstream bandwidth requirement estimates.

18. The computer readable medium of claim 15, wherein a histogram representation of the estimated bandwidth usage for a period of time of interest is displayed.

19. The computer readable medium of claim 18, wherein the histogram representation includes a representation of an estimate for bandwidth usage associated with downstream wireless signals, downstream high speed data signal, downstream VoIP signals, downstream video on demand signal, digital video broadcast signals, analog video broadcast signal, and downstream unusable spectrum.

20. The computer readable medium of claim 15, wherein the network parameters include plant parameters, video parameters, HSD parameters, VoIP parameters, and wireless parameters.

21. The computer readable medium of claim 20, wherein the processor is configured to instruct the display to display more than one network parameter is displayed simultaneously upon selection by the user.
